(19) United States
(12) Patent Application Publication
(10) Pub. No.: US 2014/0109865 A1
(43) Pub. Date: Apr. 24, 2014

(54) PRE-CHAMBER STRUCTURE FOR PISTON ENGINE

(71) Applicant: HYUNDAI MOTOR COMPANY, Seoul (KR)

(72) Inventors: Wonjun LEE, Incheon (KR); Soo Hyung WOO, Yongin-si (KR); Jin Kook KONG, Suwon-si (KR); Byong Young CHOI, Bucheon-si (KR); Gee Wook SHIN, Ansan-si (KR); Young Hong KWAK, Suwon-si (KR); Jin Soon KIM, Hwaseong-si (KR)

(73) Assignee: Hyundai Motor Company, Seoul (KR)

(21) Appl. No.: 13/714,122

(22) Filed: Dec. 13, 2012

(30) Foreign Application Priority Data
Oct. 19, 2012 (KR) 10-2012-0116829

(51) Int. Cl. F02B 19/00

(52) U.S. Cl. CPC F02B 19/00
USPC 123/260; 123/253; 123/261

(57) ABSTRACT

A pre-chamber structure for a piston engine may include: a pre-chamber combustion chamber in which a mixture of fuel and air is combusted and a pre-chamber compression chamber including a sub-chamber communicating with the pre-chamber combustion chamber and having an inclined wall surface, and a main chamber extending from the sub-chamber, thereby preventing the fuel from being adsorbed and remaining in the wall surface of the pre-chamber compression chamber in a droplet state.

### CROSS-REFERENCE TO RELATED APPLICATION

The present application claims priority of Korean Patent Application Number 10-2012-0116829 filed Oct. 19, 2012, the entire contents of which application is incorporated herein for all purposes by this reference.

### BACKGROUND OF INVENTION

1. Field of Invention

The present invention relates to a pre-chamber structure for a piston engine, and more particularly, to a pre-chamber structure for a piston engine in which a lower portion of a compression chamber facing a combustion chamber is inclinedly formed toward the combustion chamber.

2. Description of Related Art

In general, when a mixture of fuel and air is combusted inside a combustion engine, a nitrogen oxide (NOx) is formed.

The amount of the nitrogen oxide increases according to an increase in a combustion temperature, but the amount of the nitrogen oxide may be decreased by increasing a mixing ratio of the fuel and the air, that is, using a further diluted fuel mixture.

However, when the mixing ratio of the fuel and the air is increased, the fuel inside the engine may be incompletely combusted.

In order to improve efficiency of incomplete combustion, a lean burn engine employs a pre-chamber. A relatively enriched mixture of fuel and air is supplied to the pre-chamber, and the mixture is ignited and then flame thereof is spread to the combustion chamber, so that the relatively diluted mixture of fuel and air is combusted inside the combustion chamber.

A compression chamber is formed in order to supply the mixture of the fuel and the air to the pre-chamber. A pre-chamber injector for supplying fuel is installed in the compression chamber, and an air inlet for supplying air is also formed in the compression chamber. The fuel and the air are mixed and compressed in the compression chamber, so that a mixture is formed, and the mixture is supplied to the pre-chamber combustion chamber through a connection path.

A spark plug is installed in the pre-chamber combustion chamber. When the mixture of the fuel and the air is supplied from the compression chamber to the pre-chamber combustion chamber, the spark plug is ignited to combust the mixture.

The pre-chamber combustion chamber communicates with a main combustion chamber through a nozzle. The combustion flame of the mixture combusted in the pre-chamber combustion chamber is propagated to the main combustion chamber through the nozzle.

However, in the pre-chamber structure for the piston engine in the related art, since the fuel sprayed to the compression chamber is adsorbed in a wall surface of the compression chamber to remain, it is difficult to control an air-fuel ratio. Further, since the fuel adsorbed in the wall surface of the compression chamber is combusted in a droplet state, incomplete combustion is generated, so that there are concerns in generating the large amount of granular materials.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a pre-chamber structure for a piston engine having advantages of more effectively controlling an air-fuel ratio of a combustion chamber and decreasing discharge of a granular material to a minimum level by preventing incomplete combustion.

Various aspects of the present invention provide for a pre-chamber structure for a piston engine, including: a pre-chamber combustion chamber configured to combust a mixture of fuel and air to spread flame to a main combustion chamber; and a pre-chamber compression chamber including a sub-chamber communicating with the pre-chamber combustion chamber and having an inclined wall surface, and a main chamber extending from the sub-chamber.

The pre-chamber compression chamber may be disposed above the pre-chamber combustion chamber.

The sub-chamber of the pre-chamber compression chamber may have a diameter increasing as the diameter becomes closer to the upper portion.

The main chamber may be formed to have the same diameter.

An air inlet configured to take in air may be formed at one wall surface of the main chamber.

An injector configured to spray fuel to the main chamber may be inclinedly installed at one wall surface of the main chamber at the same angle as that of the inclined wall surface of the sub-chamber.

A piston may be vertically movably installed in the main chamber; and a lower portion of the piston may be inclinedly formed at the same inclined angle as that of the inclined wall surface of the sub-chamber.

The pre-chamber combustion chamber may include: a nozzle configured to spurt flame generated by combustion of the mixture; a spark plug configured to generate spark to the mixture to combust the mixture; and a check valve for preventing a back flow to the pre-chamber compression chamber.

According to the pre-chamber structure for a piston engine according to various aspects of the present invention, the injector for spraying the fuel to the pre-chamber compression chamber is also inclinedly installed and the lower portion of the piston for compressing the mixture of the fuel and the air injected to the pre-chamber compression chamber is inclinedly formed at the same angle as the inclined angle of the injector, thereby effectively preventing a phenomenon in which the fuel is adsorbed and remains in the wall surface of the pre-chamber compression chamber and a phenomenon in which the piston is stained with the fuel when the fuel is sprayed.

Further, it is possible to solve difficulty in controlling an air-fuel ratio generated because the fuel is adsorbed in the wall surface of the pre-chamber compression chamber to remain in a droplet state, and to decrease discharge of a granular material to a minimum level by preventing incomplete combustion of the fuel remaining in the droplet state.

In addition, since the lower portion of the pre-chamber compression chamber also is inclinedly formed at the same angle as the inclined angle of the piston, even though the fuel remains in the wall surface of the pre-chamber compression chamber in the droplet state, the fuel smoothly flows in the pre-chamber combustion chamber by flux of air flowing in the compression chamber and the inclined wall surface, thereby reducing fuel consumption as much as possible and effectively controlling an air-fuel ratio of the pre-chamber combustion chamber.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of an exemplary pre-chamber for a piston engine according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

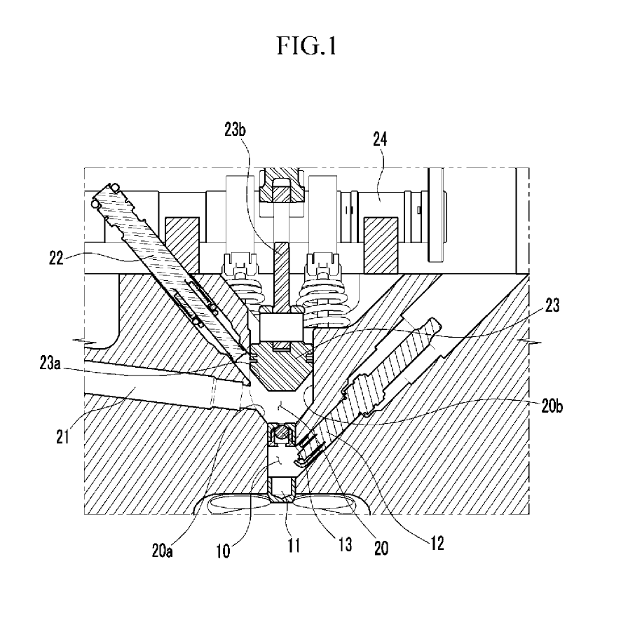

Referring to FIG. 1, a structure of a pre-chamber for a piston engine according to various embodiments of the present invention includes a pre-chamber combustion chamber 10 communicating with a main combustion chamber to spread flame to the main combustion chamber, and a pre-chamber compression chamber 20 communicating with the pre-chamber combustion chamber 10.

The pre-chamber compression chamber 20 is positioned above the pre-chamber combustion chamber 10.

A nozzle 11 for erupting the generated flame to the main combustion chamber is installed at a lower portion of the pre-chamber combustion chamber 10.

A spark plug 12 for generating spark to a mixture of fuel and air and combusting the mixture is installed at one vertical wall surface of the pre-chamber combustion chamber 10.

The spark plug 12 is inclinedly installed at the vertical wall surface.

A check valve 13 for preventing a back flow from the pre-chamber combustion chamber 10 to the pre-chamber compression chamber 20 is installed at an upper portion of the pre-chamber combustion chamber 10.

The pre-chamber compression chamber 20 includes a sub-chamber 20a communicating with the pre-chamber combustion chamber 10 and formed of an inclined wall surface of which a diameter increases as becomes closes to the upper portion thereof, and a main chamber 20b extending upwardly from the sub-chamber 20a and having substantially the same diameter.

An upper portion of the main chamber 20b is opened.

An air inlet 21 for taking in air from the outside is formed at one wall surface of the main chamber 20b, and an injector 22 for spraying the fuel to the main chamber 20b is installed above the air inlet 21.

The injector 22 is inclinedly installed upwardly in a vertical wall surface of the main chamber 20a.

A piston 23 is inserted inside the main chamber 20b through an opening formed at an upper portion of the main chamber 20b to be vertically movably installed.

A lower portion of the piston 23 is formed in the same shape as that of the sub-chamber 20a.

That is, the lower portion of the piston 23 has an inclined wall surface 23a having the same inclined angle as that of the inclined wall surface of the sub-chamber 20a and a bottom surface having the same size as that of the sub-chamber 20a.

An upper portion of the piston 23 is connected to a cam shaft 24 through a connecting rod 23b to vertically move inside the main chamber 20b by receiving rotational power of the cam shaft 24.

According to the aforementioned structure, since the injector 22 is inclinedly installed, a distance from a fuel spurt port of the injector 22 to an opposite wall surface is sufficient, so that a sufficient spraying distance from the injector 22 to the opposite wall surface may be secured. Accordingly, there is a low probability in that the fuel is adsorbed at the opposite wall surface in a droplet state and remains.

Further, the lower portion of the piston 23 is also formed of an inclined wall surface 23a having the same inclined angle as that of the injector 22, so that there is a low probability in that the piston 23 is stained with the fuel when the fuel is sprayed through the injector 22.

Further, even though the wall surface of the main chamber 20b and the inclined wall surface of the sub-chamber 20a are stained with the fuel sprayed by the injector 22, the fuel smoothly flows in the pre-chamber combustion chamber 10 through flux of the air flowing in through the main chamber 20b and the inclined wall surface of the sub-chamber 20a.

For convenience in explanation and accurate definition in the appended claims, the terms upper or lower, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A pre-chamber structure for a piston engine, comprising:
a pre-chamber combustion chamber configured to combust a mixture of fuel and air to spread flame to a main combustion chamber; and
a pre-chamber compression chamber comprising a sub-chamber communicating with the pre-chamber combustion chamber and having an inclined wall surface, and a main chamber extending from the sub-chamber.

2. The pre-chamber structure of claim 1, wherein:
the pre-chamber compression chamber is disposed above the pre-chamber combustion chamber.

3. The pre-chamber structure of claim 2, wherein:
the sub-chamber of the pre-chamber compression chamber has a diameter increasing as the diameter becomes closer to the upper portion.

4. The pre-chamber structure of claim 3, wherein:
the main chamber is formed to have the same diameter.

5. The pre-chamber structure of claim 1, wherein:
an air inlet configured to take in air is formed at one wall surface of the main chamber.

6. The pre-chamber structure of claim 1, wherein:
an injector configured to spray fuel to the main chamber is inclinedly installed at one wall surface of the main chamber at the same inclined angle as that of the inclined wall surface of the sub-chamber.

7. The pre-chamber structure of claim 1, wherein:
a piston is vertically movably installed in the main chamber; and
a lower portion of the piston is inclinedly formed at the same inclined angle as that of the inclined wall surface of the sub-chamber.

8. The pre-chamber structure of claim 1, wherein:
the pre-chamber combustion chamber comprises:
a nozzle configured to spurt flame generated by combustion of the mixture;
a spark plug configured to generate spark to the mixture to combust the mixture; and
a check valve for preventing a back flow to the pre-chamber compression chamber.

9. A pre-chamber structure for a piston engine, comprising:
a pre-chamber combustion chamber in which a mixture of fuel and air is combusted; and
a pre-chamber compression chamber comprising a sub-chamber communicating with the pre-chamber combustion chamber and having an inclined wall surface, and a main chamber extending from the sub-chamber,
wherein an injector configured to spray fuel to the main chamber is inclinedly installed at one wall surface of the main chamber at the same inclined angle as that of an inclined wall surface of the sub-chamber,
a piston is vertically movably installed in the main chamber, and
a lower portion of the piston is inclined at the same inclined angle as that of an inclined wall surface of the sub-chamber.

10. The pre-chamber structure of claim 9, wherein:
the pre-chamber compression chamber is disposed above the pre-chamber combustion chamber.

11. The pre-chamber structure of claim 10, wherein:
the sub-chamber of the pre-chamber compression chamber has a diameter increasing as the diameter becomes closer to the upper portion.

12. The pre-chamber structure of claim 11, wherein:
the main chamber is formed to have the same diameter.

13. The pre-chamber structure of claim 9, wherein:
an air inlet configured to take in air is formed at one wall surface of the main chamber.

14. The pre-chamber structure of claim 9, wherein:
the pre-chamber combustion chamber comprises:
a nozzle configured to spurt flame generated by combustion of the mixture;
a spark plug configured to generate spark to the mixture to combust the mixture; and
a check valve for preventing a back flow to the pre-chamber compression chamber.
